(19) United States
(12) Patent Application Publication
(10) Pub. No.: US 2013/0333475 A1
(43) Pub. Date: Dec. 19, 2013

(54) DEVICE AND METHOD FOR PICKLING AND SIMULTANEOUSLY CHECKING A PART BY ACOUSTIC MEANS

(71) Applicants: Hubert Voillaume, Issy Les Moulineaux (FR); Benjamin Campagne, Saint Herblin (FR); Franck Benthouhami, Chavannes En Paillers (FR)

(72) Inventors: Hubert Voillaume, Issy Les Moulineaux (FR); Benjamin Campagne, Saint Herblin (FR); Franck Benthouhami, Chavannes En Paillers (FR)

(73) Assignee: AIRBUS OPERATIONS (S.A.S), Toulouse (FR)

(21) Appl. No.: 13/981,157

(22) PCT Filed: Jan. 25, 2012
(86) PCT No.: PCT/EP12/51163

§ 371 Date: Sep. 4, 2013

(30) Foreign Application Priority Data
Jan. 27, 2011 (FR) 1150643

(51) Int. Cl. G01N 29/265

(52) U.S. Cl. CPC G01N 29/265
USPC 73/643

(57) ABSTRACT

A device for implementing a method for pickling/stripping and for simultaneously non-destructively checking a part (100), the device including:
a. an energizing laser head capable of generating pulsed energisation (212) on the surface of a part (100, 300) according to an energy spectrum adapted for the detachment of the particles (231) adhering to the surface;
b. a detection laser head (220) connected to the energizing laser head and capable of measuring the response of the part to a pulse generated by the energizing head.

The invention relates to a device and a method for pickling and simultaneously checking a part. It is inscribed within the field of non-destructive testing and is particularly suited to the surface treatment and inspection of the material integrity of parts with large dimensions made from composite material.

The material integrity inspection for large parts is a particularly long operation and is essential for parts whose in-service behaviour is critical, particularly in the aeronautics field.

Among the non-destructive testing methods particularly suited to detecting defects capable of developing in a catastrophic manner when in service, ultrasonic testing consists in emitting a surface energisation so as to generate a mechanical wave which travels through the volume of the part. Any discontinuity present in said part, such as a crack or delamination of a part made from stratified composite material, modifies the conditions by which this wave travels by creating an observable echo and/or attenuation or diffraction of the latter. These phenomena, which can be detected at the surface of the part by measuring the characteristics of the wave transmitted or reflected, thus enable the detection of the defects causing this discontinuity.

Inspecting a part by ultrasonic testing requires the latter to be scanned by a transmission source, capable of generating the mechanical energisation of the surface of the part, and by a sensor capable of measuring the part's response. It is this scanning process that is the most time-consuming.

The use of a mechanical device, such as a piezoelectric device, to energise the surface of the part and to measure its response, requires the use of a coupling agent, such as water, between said device and the energised surface. For automatic part testing, this is often immersed in a pool, which thus requires facilities with very high volume capacities for testing parts with large dimensions.

Document U.S. Pat. No. 4,137,778 describes a device and method sequentially using multiple laser sources with differing characteristics for pickling and non-destructively testing a metal part. The method and device described in this document therefore require at least two different laser pulses, one being used for pickling and the other for non-destructive testing. The metallic aspect of the part inspected by the device described in this document is essential. Indeed, for a metal, the light reflected on the surface when clean produces a threshold effect, preventing successive laser shots from deteriorating said surface. For composite materials, as targeted by this invention, the surface of these materials does not reflect or reflects the light ray very little and therefore does not benefit from this threshold effect.

The purpose of the invention is to overcome the disadvantages of the prior art by proposing a method for inspecting the surface of a composite part with fibrous reinforcements in a dry environment, said method comprising the following steps:

a. energising the surface of the part by a thermoelastic energy pulse using a laser to produce a disruption capable of detaching the particles adhering to said surface and an acoustic wave capable of travelling through the part;

b. measuring the acoustic response of the part to the energisation generated in step a) so as to detect any discontinuities capable of affecting the capacity of the wave to travel through the thickness of the part.

The method of the invention therefore combines the pickling operations, also known as stripping operations, of the part and advantageously uses the wave generated during this phase to conduct the ultrasonic testing of said part. The inspection method takes place concurrently with the stripping/pickling method, which generally takes place prior to painting the part. Moreover, the method allows for the use of a higher energisation power and therefore improves the detection of defects, in particular for parts with high thicknesses. A single laser shot is used, which prevents deterioration to the surface caused by successive shots. Given that the method is implemented in a dry environment, no immersion device is required. These various characteristics of the method therefore work together to provide for the automatic, concurrent inspection of a part with large dimensions.

The invention can be implemented according to the advantageous embodiments described hereinbelow, which can be considered singly or according to any combinations technically possible.

Advantageously, the acoustic response is measured by laser interferometry, which allows for a contactless measurement without the need for a coupling agent. This configuration is particularly advantageous when the response is measured on the same surface as the energisation. The contactless, couplant-free measurement is not as disrupted by the pickling effects.

Advantageously, the pulse energy generated in step a) is 6 joules for a pulse duration of 100 ns. These energisation conditions are designed to suit the combination of pickling and non-destructive testing functions.

Advantageously, the pulse energy is distributed over a substantially rectangular surface area measuring 5×40 mm². This surface area is wide enough for part pickling operations by scanning within timeframes compatible with industrial production, yet remains compatible with the detection of the defects searched for in composite materials with fibrous reinforcements.

The invention also relates to a device for implementing the method of the invention according to any one of its embodiments, said device comprising:
a. an energising laser head such as a TEA CO2 laser head capable of generating a pulsed energisation on the surface of a part;
b. a detection laser head connected to the energising laser head (310, 110);
c. means for producing a controlled, relative movement of the laser heads in relation to the part;
d. a confocal interferometer such as a Fabry-Pérot interferometer.

Such a device is capable of combining a surface pickling operation, via an energising source with suitable power, and a material integrity inspection for the pickled part by measuring the energisation response generated by the first source using an interferometer. “TEA” is the abbreviation of “Transversally Excited Atmospheric”. A TEA CO2 laser describes a laser obtained by exciting carbon dioxide under atmospheric pressure. This laser beam generation principle is known in the prior art. This type of laser is particularly well suited to the generation of a pulsed energisation with controlled characteristics, both for non-destructive testing and for pickling/stripping. The movement means enable the surface of the part to be scanned, both for inspection and pickling/stripping purposes, such that these operations are performed in an automatic manner.

Advantageously, the energising head laser is capable of generating a pulse over a duration of 100 ns (100. 10⁻⁹ s) for an energy density of 2.5 J.cm⁻². These conditions are optimal for combining ultrasonic testing and pickling/stripping within the same operation, more particularly when the part is made from composite material.

Advantageously, the device of the invention comprises data acquisition and storage means in addition to display means capable of mapping the acoustic response of the part. The part can therefore be easily inspected by an operator not specialised in ultrasonic testing.

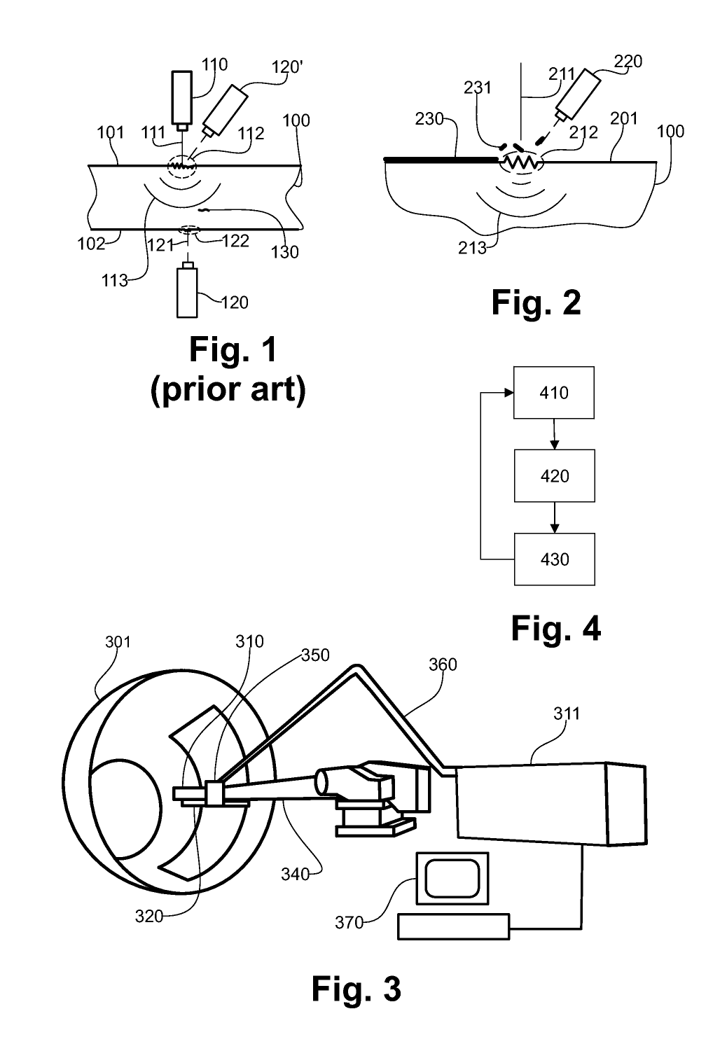

The invention shall now be described in more detail within the scope of its preferred embodiments, which in no way limit the invention, and in FIGS. 1 to 4, wherein:

FIG. 1 from the prior art represents a front view and cross-section of the inspection principle for a part by the generation of ultrasonic waves travelling through the part and generated by the thermoelastic energisation of the surface of a part by means of a laser;

according to the same view as in FIG. 1, FIG. 2 shows the principle of a pickling/stripping operation by thermoelastic energisation of the surface of a part by means of a laser combined with the non-destructive testing of said part by the generation of an ultrasonic wave travelling through the part;

FIG. 3 is a perspective view of one embodiment of the device of the invention for simultaneously pickling/stripping and non-destructively testing a part with large dimensions;

FIG. 4 is a logic diagram of one embodiment of the method of the invention.

In FIG. 1, according to one embodiment and known in the prior art, the ultrasonic testing of a part using a laser consists in generating localised energisation (112) on the surface (101) of a part (100) by thermoelastic effect, exposing a small surface of the part to the energy transmitted in the form of a pulse by a laser ray (111) generated by an appropriate source (110). This thermoelastic disruption of the surface (101) produces a mechanical wave (113), which elastically travels through the part at the speed of sound in the medium making up said part. It produces a deformation (122) of the opposite surface (102) of the part when it reaches said surface (102), on which the wave (113) is reflected so as to travel back through the part. This deformation of the surface (102) can be measured by another laser device (120), pointing a laser measurement ray (121) in the direction of said surface. The measurement principle is known in the prior art and is not described in more detail. This is an interferometry measurement, which detects the speed of deformation of the surface (102) by Doppler effect. According to one simple example of application, the measurement of the time between the generation of the pulse causing the first thermoelastic disruption (112) and its detection by the deformation (112) of the opposite surface, enables the thickness of the part to be measured given the known speed of propagation of the elastic waves through this part. This principle can be advantageously used for the non-destructive testing of the part (100) over its thickness. Therefore, by no longer positioning the detection laser (120′) on the free surface (102) opposite the surface (101) subject to the initial pulsed thermoelastic disruption (112), but on the same side as the latter, and in the presence of a defect (130) within the part (100), a portion of the elastic wave (113) will be reflected from this defect (130) which, via the propagation of this reflected wave, will return to the emission surface (101) where it can be detected by the measuring device (120′), all the more so as this measuring device (120′) detects the bottom echo corresponding to the reflection of the elastic wave (113) on the opposite surface (102) of the part (100). The wave reflected from the defect (130) returns to the emission surface (101) before the bottom echo, so that the measurement of a disruption on the surface (101) before the bottom echo confirms the presence of a discontinuity, and the measurement of the time between measuring this surface deformation and the time of emission of the initial pulse (112) is used to determine the depth of the defect (130) in relation to the emission surface (101).

Stripping consists in pickling the surface of a part to remove the surface layers, which can be oxidised, slightly cohesive or contaminated layers. This operation is essential before any surface protection or coating operation to guarantee the cohesion of said coating to the surface. According to the prior art, these stripping operations are performed by chemical or mechanical methods.

Mechanical stripping consists in projecting onto the surface a means which, via its kinetic energy, results in the ablation of a surface layer more or less significant in size. Said projected means can be in the form of more or less hard and/or abrasive, solid particles such as sand, glass beads or plastic materials, ice or ground ligneous material. A water jet with or without abrasive can also be used for this purpose.

In FIG. 2 according to one embodiment of the invention, the pickling/stripping operation consists in using a source of local ultrasonic mechanical energisation for stripping. According to this non-limitative example, the source of ultrasonic energisation is a laser ray (211) producing, by thermoelastic effect, a local disruption (212) on the surface (201) of the part. Other sources of local ultrasonic energisation can also be used.

The use of ultrasound for pickling/stripping is known in the prior art. According to the prior art, this technique is reserved for use with parts of small dimensions, as it consists in placing said parts in a tank containing a fluid and in subjecting said tank to ultrasonic energisation.

In the embodiment of the device of the invention represented in FIG. 2, the ultrasonic energisation is localised, which in particular allows this to be performed by a laser (211). The local thermoelastic disruption (212) resulting from this energisation of the surface (201) of the part (100), detaches a more or less deep surface layer (230) by mechanical effect, i.e. by the difference in deformation between the zone solicited and the rest of the part (100), and/or by thermal effect if the temperature of the surface exposed to the laser (212) exceeds the evaporating temperature of said layer. The surface layer thus affected is broken down into debris (231). To strip the entire surface (201) of the part, the source of energisation (211) must be moved so as to cover the entire surface, which is detrimental to productivity under industrial conditions.

The device of the invention overcomes this disadvantage by combining this stripping/pickling operation with a non-destructive testing operation for the part (100). The local energisation (212) of the surface of the part by an ultrasonic source in view of its pickling/stripping is taken advantage of by adding a measuring device (220) to measure the effects of the reflection of the ultrasonic wave (213) generated for each pulse, and thus for testing the part via the possibility of detecting the presence of defects in the thickness of the latter during each shot. The pickling/stripping operation is therefore performed concurrently during the non-destructive test for the part and does not affect the overall cycle time for the part's manufacture.

The device of the invention is also particularly advantageous for inspecting thick parts, particularly if made from composite material with fibrous reinforcements. According to the prior art, the use of ultrasound waves generated by a laser is in this case limited due to the risk of deteriorating the surface of the part inspected, as this requires a high energisation power. By wisely choosing the energisation parameters, the device of the invention provides for an energisation power high enough for inspecting the thick parts, where the energisation causes a controlled and desired “deterioration” of the surface in the form of pickling/stripping. The term “deterioration” is placed between inverted commas in order to differentiate between the technical effect of the invention, i.e. stripping, which takes place voluntarily with the aim of adding value to the part (100) undergoing the inspection, and the involuntary and undesired effect produced unintentionally according to the prior art, during a non-destructive test using a high stress power, the effect of which results in an internal failure cost for the part undergoing the test.

According to one particularly advantageous example of application, more particularly suited but not limited to the inspection of parts made from composite material comprising a polymer resin reinforced using carbon fibres, the device of the invention uses a TEA CO2-type laser with a wavelength of 10.6 μm (10.6.10⁻⁶ m) for the pulsed energisation of the surface (201).

According to this embodiment, the device advantageously uses a pulse energy of 6 joules for a pulse duration of 100 ns (100.10⁻⁹ s), with this energy being distributed throughout a substantially rectangular surface area of 5×40 mm², i.e. with an energy density of 2.5 J. cm⁻².This energy density is approximately five times larger than that commonly used for pulsed energisation of a surface in view of non-destructive testing.

In FIG. 3 according to one embodiment, the device of the invention is adapted to suit the simultaneous non-destructive testing and stripping of parts with large dimensions, and in particular of parts used to form the structure of an aircraft (301). According to this embodiment, an effector carrier (350) receives a first laser head (310) such as a TEA CO2 laser head and known as an energising laser head, for the pickling/stripping and pulsed energisation of the surface of the part (301) subject to the operation. The CO2 laser is produced by a generator (311) and conveyed to the head (320) by means (360) known in the prior art.

The effector carrier (350) also supports a second laser head (320), known as a detection laser head, for measuring surface deformations by interferometry. This second laser head (320) is an Nd-YAG-type laser head or, according to one preferred embodiment, the detection laser is a pulsed fibre laser using a wavelength of 1 μm (10⁻⁶ m). The detection is advantageously performed by Doppler interferometry, measuring the surface vibration speed using a confocal interferometer such as a Fabry-Pérot interferometer.

The effector carrier (350) is supported by a robotic arm (340), which scans the surface being inspected. A computer device (370) controls the movements of the robotic arm and collects and processes the measurements taken. The robotic arm is controlled via a file containing a digital description of the surface, often a digital model of the part (301).

In FIG. 4 according to one embodiment, the device of the invention allows for the implementation of a pickling/stripping method comprising a first step (410) consisting in energising the surface with a pulsed laser source, distributing a specific energy of 2.5 J. cm⁻² so as to break down a layer (230) on the surface of the part (100, 301), followed by a second step (420) consisting in measuring the response of the part to this local solicitation with the purpose of detecting defects (130) in the thickness of the material located underneath the energised surface of the part. During a next step (430), the effector carrier is moved in relation to the surface of the part, before generating a new energisation (step 410) so that the surface lit up by the energisation laser partially overlaps the previously solicited surface.

The description hereinabove clearly illustrates that this invention achieves the objectives targeted given its different characteristics and their advantages. It in particular enables the concurrent non-destructive testing of the material integrity of an entire part with large dimensions to take place during a surface stripping/pickling operation. By implementing movement means (340) for scanning purposes, the device of the invention is highly versatile and allows for the automatic stripping/pickling of a wide variety of parts. The coming together of these two methods, i.e. of the pickling/stripping and the non-destructive testing operations, creates synergies. The use of an increased energisation power improves the non-destructive testing method, in particular by producing conditions that are more favourable to the inspection of thick parts. The possibility of combining the pickling/stripping operation with the non-destructive testing operation for the part makes such an operation, performed by surface scanning, economically profitable.

1-8. (canceled)

9. A method for the dry pickling of the surface of a part made from composite material with fibrous reinforcements, comprising the following steps:
a. energising the surface of the part by a thermoelastic energy pulse using a laser to produce a disruption capable of detaching the particles adhering to said surface and an acoustic wave capable of travelling through the part;
characterised in that it comprises the following step:
b. measuring the acoustic response of the part to the energisation generated in step a) so as to detect any discontinuities capable of affecting the capacity of the wave to travel through the thickness of the part.

10. The method according to claim 9, wherein the acoustic response is measured by laser interferometry.

11. The method according to claim 9 wherein the pulse energy generated in step a) is 6 joules for a pulse duration of 100 ns.

12. The method according to claim 11, wherein the pulse energy is distributed over a substantially rectangular surface area measuring 5×40 mm².

13. A device for implementing a method according to claim 12, characterised in that it comprises:
a. an energising laser head such as a TEA CO2 laser head capable of generating a pulsed energisation on the surface of a part;
b. a detection laser head connected to the energising laser head;
c. means for producing a controlled, relative movement of the laser heads in relation to the part;
d. a confocal interferometer such as a Fabry-Pérot interferometer.

14. The device according to claim 13, wherein the detection laser is an Nd-YAG-type laser.

15. The device according to claim 13, wherein the detection laser is a pulsed fibre laser using a wavelength of 1 μm.

16. The device according to claim 13, wherein it comprises data acquisition and storage means in addition to display means capable of mapping the acoustic response of the part.
